(19) United States
(12) Patent Application Publication
(10) Pub. No.: US 2026/0353494 A1
(43) Pub. Date: Nov. 5, 2026

(54) METHODS, COMMUNICATIONS DEVICES, AND INFRASTRUCTURE EQUIPMENT

(71) Applicant: Sony Group Corporation, Tokyo (JP)

(72) Inventors: Samuel Asangbeng ATUNGSIRI, Basingstoke (GB); Shin Horng WONG, Basingstoke (GB); Martin Warwick BEALE, Basingstoke (GB)

(73) Assignee: Sony Group Corporation, Tokyo (JP)

(21) Appl. No.: 19/105,062

(22) PCT Filed: Sep. 27, 2023
(86) PCT No.: PCT/EP2023/076741

§ 371 Date: Feb. 20, 2025

(30) Foreign Application Priority Data
Sep. 30, 2022 (EP) 22199303.3

(51) Int. Cl. H04W 76/16; H04W 36/32; H04W 72/231; H04W 74/0833; H04W 76/20; H04W 80/02

(52) U.S. Cl. CPC H04W 76/16; H04W 36/322; H04W 72/231; H04W 74/0833; H04W 76/20; H04W 80/02

(57) ABSTRACT

A method of operating a communications device is provided. The method comprises transmitting, to a cell of a wireless communications network, a first uplink signal based on a first waveform type, determining that the communications device is to transmit a second uplink signal based on a second waveform type instead of the first waveform type based on a predetermined condition being met, the second waveform type being different to the first waveform type, and transmitting, to the cell of the wireless communications network, the second uplink signal based on the second waveform type. Here, the predetermined condition may comprise (or may otherwise be indicative of) the communications device moving outside of an uplink coverage region of the cell of the wireless communications network.

### BACKGROUND

### Field of Disclosure

The present disclosure relates to communications devices, infrastructure equipment and methods for the more efficient operation of communications devices and infrastructure equipment in a wireless communications network.

The present application claims the Paris Convention priority from European Patent Application number EP22199303.3, filed on 30 Sep. 2022, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current wireless communications networks, for example those which may be referred to as 5G or new radio (NR) systems/new radio access technology (RAT) systems, or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems.

5G NR has continuously evolved and the current work plan includes 5G-NR-advanced in which some further enhancements are expected, especially to support new use-cases/scenarios with higher requirements. The desire to support these new use-cases and scenarios gives rise to new challenges for efficiently handling communications in wireless communications systems that need to be addressed.

### SUMMARY OF THE DISCLOSURE

The present disclosure can help address or mitigate at least some of the issues discussed above.

Embodiments of the present technique can provide a method of operating a communications device. The method comprises transmitting, to a cell of a wireless communications network, a first uplink signal based on a first waveform type, determining that the communications device is to transmit a second uplink signal based on a second waveform type instead of the first waveform type based on a predetermined condition being met, the second waveform type being different to the first waveform type, and transmitting, to the cell of the wireless communications network, the second uplink signal based on the second waveform type. Here, the predetermined condition may comprise the communications device moving outside of an uplink coverage region of the cell of the wireless communications network.

Embodiments of the present technique, which, in addition to methods of operating communications devices, relate to methods of operating infrastructure equipment, communications devices and infrastructure equipment, circuitry for communications devices and infrastructure equipment, computer programs, and computer-readable storage mediums, can allow for the more efficient use of radio resources by a communications device operating in a wireless communications network.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIGS. 4A and 4B illustrate how initial access and/or uplink small data transmissions (SDT) may be performed by a user equipment (UE) using random access (RACH) schemes while the UE is in an idle or inactive state;

FIG. 5 shows a part schematic, part message flow diagram representation of a wireless communications system comprising a communications device and an infrastructure equipment in accordance with embodiments of the present technique; and

FIG. 6 shows a flow diagram illustrating a process of communications in a communications system in accordance with embodiments of the present technique.

### DETAILED DESCRIPTION OF THE EMBODIMENTS

### Long Term Evolution Advanced Radio Access Technology (4G)

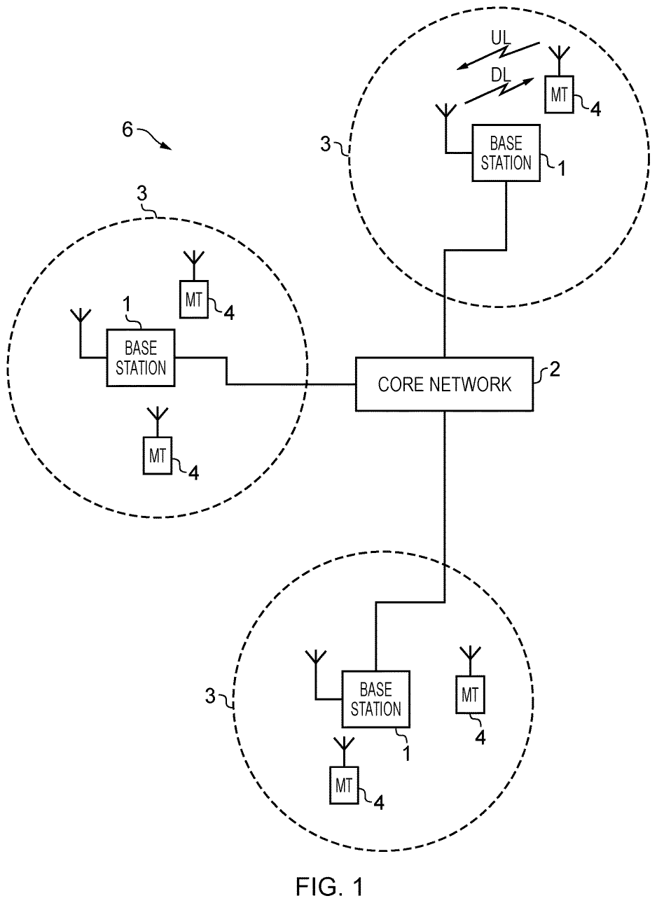

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink (DL). Data is transmitted from communications devices 4 to the base stations 1 via a radio uplink (UL). The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable and Low Latency Communications (URLLC) services are for one transmission of a 32 byte packet to be transmitted from the radio protocol layer 2/3 SDU ingress point to the radio protocol layer 2/3 SDU egress point of the radio interface within 1 ms with a reliability of 1−10⁻⁵ (99.999 %) or higher (99.9999%) [2].

Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

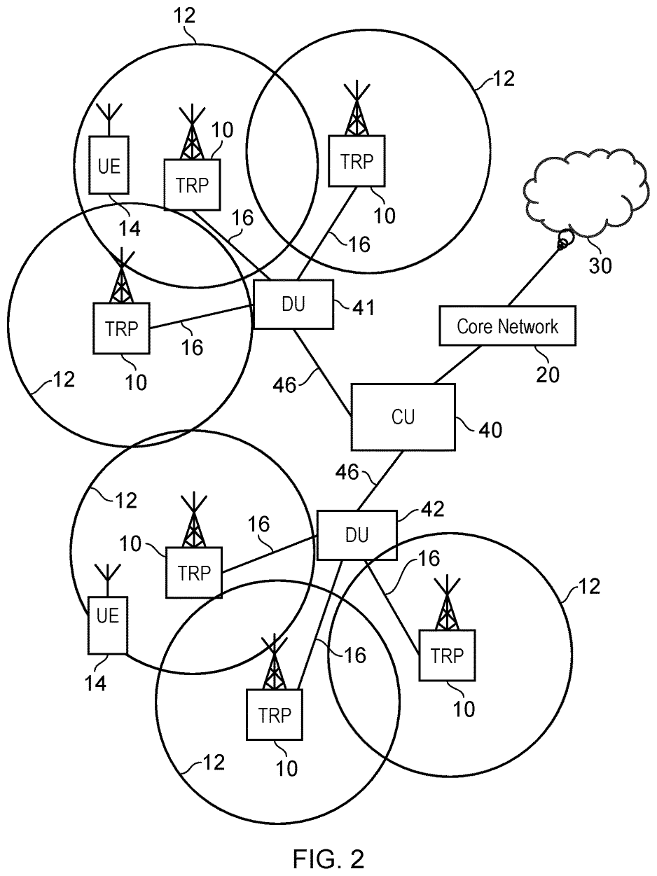

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

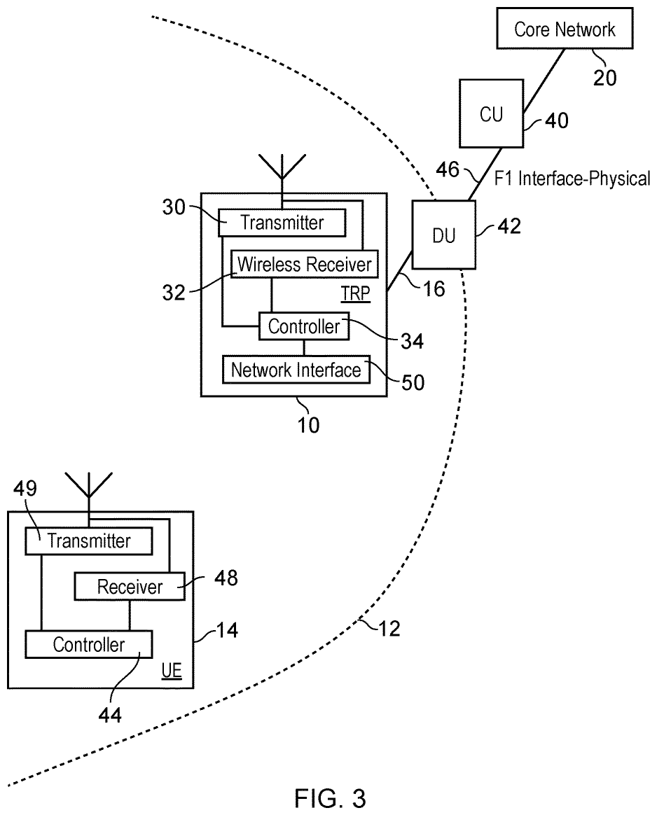

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

### RACH Procedures in LTE and NR

In wireless telecommunications networks, such as LTE and NR type networks, there are different Radio Resource Control (RRC) modes for terminal devices. For example, it is common to support an RRC idle mode (RRC_IDLE) and an RRC connected mode (RRC_CONNECTED). A terminal device in the idle mode may transition to connected mode, for example because it needs to transmit uplink data or respond to a paging request, by undertaking a random access procedure. The random access procedure involves the terminal device transmitting a preamble on a physical random access channel (PRACH) and so the procedure is commonly referred to as a RACH or PRACH procedure/process, where such RACH procedures might comprise four steps or two steps, as described in greater detail below.

As those skilled in the art would understand, as well as a UE performing a RACH procedure to perform initial access by transitioning from RRC_IDLE to RRC_CONNECTED for example, a UE might perform a RACH based scheme (e.g. 2-step RACH or 4-step RACH) while in the RRC_INACTIVE state for reasons like the performing of small data transmissions (SDT) without having to first transition to the RRC_CONNECTED state with the network.

In addition to a terminal device deciding itself to initiate a random access procedure to connect to the network, it is also possible for the network, e.g. a base station, to instruct a terminal device in connected mode to initiate a random access procedure by transmitting to the terminal device an instruction to do so. Such an instruction is sometimes referred to as a Physical Downlink Control Channel (PDCCH) order to RACH.

There are various scenarios in which a network triggered RACH procedure (PDCCH order) may arise.

For example:
a terminal device may receive a PDCCH order to transmit on PRACH as part of a handover procedure;
a terminal device that is RRC connected to a base station but has not exchanged data with the base station for a relatively long time may receive a PDCCH order to cause the terminal device to transmit a RACH preamble so that it can be re-synchronised to the network and allow the base station to correct timings for the terminal device;
a terminal device may receive a PDCCH order so that it can establish a different RRC configuration in the subsequent RACH procedure, this may apply, for example, for a narrowband IoT terminal device which is prevented from RRC reconfiguration in connected mode whereby sending the terminal device to idle mode through a PDCCH order allows the terminal device to be configured in the subsequent PRACH procedure, for example to configure the terminal device for a different coverage enhancement level (e.g. more or fewer repetitions).

For convenience, the term PDCCH order is used herein to refer to signalling transmitted by a base station to instruct a terminal device to initiate a PRACH procedure regardless of the cause. However, it will be appreciated such an instruction may in some cases be transmitted on other channels/in higher layers. For example, in respect of an intra-system handover procedure, what is referred to here as a PDCCH order may be an RRC Connection Reconfiguration instruction transmitted on a downlink shared channel / PDSCH.

When a PDCCH order is transmitted to a terminal device, the terminal device is assigned a PRACH preamble signature sequence to use for the subsequent PRACH procedure. This is different from a terminal device triggered PRACH procedure in which the terminal device selects a preamble from a predefined set and so could by coincidence select the same preamble as another terminal device performing a PRACH procedure at the same time, giving rise to potential contention. Consequently, for PRACH procedures initiated by a PDCCH order there is no contention with other terminal devices undertaking PRACH procedures at the same time because the PRACH preamble for the PDCCH ordered terminal device is scheduled by the network/base station.

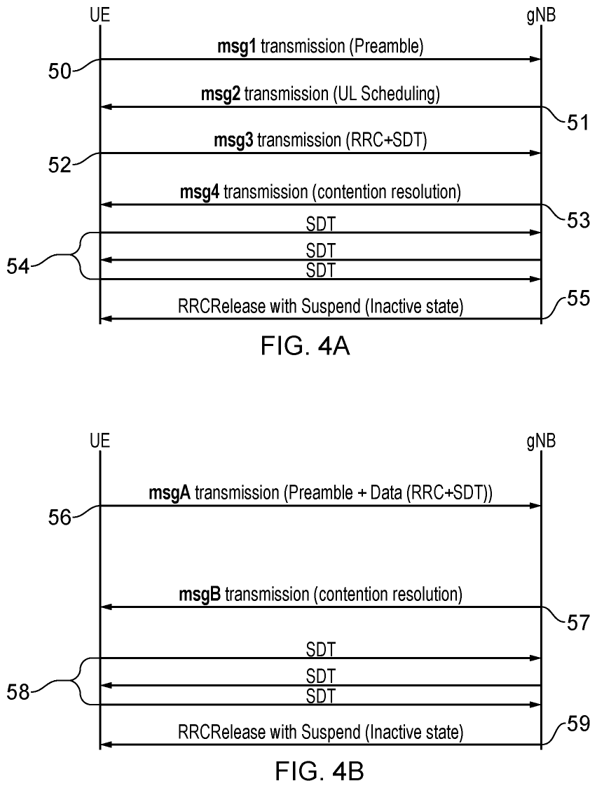

FIG. 4A shows an example of the 4-step RACH based scheme, and also shows how mobile originating (MO) SDTs can be initiated by such a scheme. When a UE wants or is ordered to perform initial access, or when the UE has an UL SDT ready for transmission, it may start a 4-step RACH procedure as shown in FIG. 4A, which comprises the following steps:
A UE in either RRC IDLE or RRC_INACTIVE starts message 1 (Msg1) transmission 50 of a Physical Random Access (PRACH) preamble that is associated with a particular preamble ID, and may be selected by the UE from a set of preambles allocated for SDT in the current cell. When a gNB receives the preambles, it identifies the UE, and/or identifies the (Msg1) as an SDT initiation, and responds with message 2 (Msg2);
The gNB transmits 51 (Msg2), which contains a Random Access Response (RAR) message in response to the RACH preamble transmitted as part of the initial access procedure, where the RAR comprises the RACH preamble ID (RAPID), an UL timing alignment command, UL PUSCH scheduling for message 3 (Msg3), and a temporary Cell Radio Network Temporary Identifier (C-RNTI);
The UE transmits 52 (Msg3), which contains the temporary C-RNTI it received in Msg2 to identify the UE, Radio Resource Control (RRC) signalling (i.e. an RRCConnectRequest for initial access or RRCResumeRequest for initiating an SDT) and SDT data if there is any remaining space within the scheduled PUSCH;
The gNB then provides 53 the contention resolution after the UE that transmitted the preamble in the first step 50 is identified via the temporary C-RNTI it received in Msg2 and confirmed. In this step 53, DL and UL feedback or acknowledgments are transmitted if any small data was transmitted by the UE;
   For UL feedback received by a gNB from a UE in response to transmitting a DL PDSCH to that UE, a Hybrid Automatic Repeat Request Acknowledgement (HARQ-ACK) is transmitted on a cell-specific Physical Uplink Control Channel (PUCCH) resource configured within the system information (though it should be noted that, that from the third step 52, the UE is already UL-synchronised); and
   For DL feedback received by a UE in response to transmitting the UL (Msg3) in the third step 52, the reception of message 4 (Msg4) in the fourth step 53 at the UE is considered as a positive acknowledgment; and
After the fourth step 53, if the UE was performing the RACH procedure for the purposes of initial access, a connection has now been established and the UE now transitions to the RRC_CONNECTED state. Elsewise, if the UE is performing the RACH procedure for the purposes of SDT, the UE is now already identified by the network and is also UL-synchronised. Hence, if the UE is performing small data transmission while in the RRC_INACTIVE state, subsequent UL and DL SDT with dynamic scheduling can take place 54 as required while the UE remains in the INACTIVE state. Likewise, if the UE is now in RRC_CONNECTED, it can transmit and receive data in general to and from the network though dynamic scheduling or using configured grants. Later, once SDT is completed, and neither the gNB nor UE have any further data to transmit, the gNB can choose to keep the UE in RRC_INACTIVE state by sending RRCRelease with suspend indication 55.

FIG. 4B shows an example of the 2-step RACH based scheme, and also shows how MO SDTs can be initiated by such a scheme. When a UE wants or is ordered to perform initial access, or has an UL SDT ready for transmission, it may start a 2-step RACH procedure as shown in FIG. 4B, which comprises the following steps:
A UE in either RRC_IDLE or RRC_INACTIVE starts msgA transmission 56 of a PRACH preamble that is associated with a particular preamble ID, and may be selected by the UE from a set of preambles allocated for SDT in the current cell, and msgA also comprises an associated PUSCH (i.e. for SDT) in the current cell. The PUSCH contains RRC signalling (i.e. an RRCConnectRequest for initial access or RRCResumeRequest for initiating an SDT) and SDT data if there is any remaining space within the PUSCH;
Similarly to the general 4-step RACH procedure, when a gNB receives 56 msgA it recognises that a UE has initiated the RACH procedure, and/or identifies this as an SDT initiation and responds 57 with msgB which contains either a Random Access Response (RAR) message in response to the RACH preamble transmitted as part of the initial access procedure, where the RAR comprises the RAPID, an UL timing alignment command, a C-RNTI, and the contention resolution where the UE which transmitted 56 msgA in the first step is identified and confirmed. In this step 57, DL and UL feedback or acknowledgments are transmitted;
   For UL feedback received by a gNB from a UE in response to a DL PDSCH being transmitted by the gNB to that UE, a HARQ-ACK is transmitted by the UE on a cell-specific PUCCH resource configured within the system information; and
   For DL feedback received by a UE from the gNB in response to msgA being transmitted 56 by that UE, the reception 57 of msgB at the UE is considered as a positive acknowledgment; and
After the second step 57, if the UE was performing the RACH procedure for the purposes of initial access, a connection has now been established and the UE now transitions to the RRC_CONNECTED state. Elsewise, if the UE is performing the RACH procedure for the purposes of SDT, the UE is now already identified by the network and is also UL-synchronised. Hence, if the UE is performing small data transmission while in the RRC_INACTIVE state, subsequent UL and DL SDT with dynamic scheduling can take place 58 as required while the UE remains in the INACTIVE state. Likewise, if the UE is now in RRC_CONNECTED, it can transmit and receive data in general to and from the network though dynamic scheduling or using configured grants. Later, once SDT is completed, and neither the gNB or UE have any further data to transmit, the gNB can choose to keep the UE in RRC_INACTIVE state by sending RRCRelease with suspend indication 59.

### Configured Grant

As is well understood by those skilled in the art, a UE uses a Physical Uplink Shared Channel (PUSCH) for uplink data transmission. The PUSCH resources used for the transmission of the PUSCH can be scheduled by a gNB using a Dynamic Grant (DG) or a Configured Grant (CG).

In a Dynamic Grant PUSCH (DG-PUSCH), the UE typically sends a Scheduling Request (SR) to the gNB when uplink data arrives at its buffer. In response to receiving the SR, the gNB would then send an Uplink Grant, e.g. via Downlink Control Information (DCI) using DCI Format 0_0, 0_1 or 0_2, carried by a Physical Downlink Control Channel (PDCCH) to the UE where this Uplink Grant schedules resources for a PUSCH. The UE then uses the scheduled PUSCH (i.e. DG-PUSCH) to transmit its uplink data.

It is observed that the use of DG-PUSCHs introduces latency, since the UE needs to initiate an SR and has to wait for an Uplink Grant before it is scheduled PUSCH resources. For regular and periodic traffic, DG-PUSCH would lead to multiple SR and Uplink Grants being sent which is not an efficient use of resources. Hence, recognising the drawbacks of DG-PUSCH, Configured Grant PUSCH (CG-PUSCH) is introduced in NR. In CG-PUSCH, the UE is pre-configured using Radio Resource Control (RRC) configuration periodic PUSCH resources, such that the UE can transmit its uplink data in any of these regularly occurring CG-PUSCH resources without the need to request it with an SR. There are two types of CG-PUSCH:
Type 1 CG-PUSCH: Once the CG-PUSCH resource is configured by RRC, the UE can use it without activation; and
Type 2 CG-PUSCH: The CG-PUSCH resource is firstly RRC configured. The UE can only use the CG-PUSCH resource if it receives an activation DCI, which is an UL Grant with a Configured Scheduling-Radio Network Temporary Identifier (CS-RNTI). Once the CG-PUSCH is activated the UE can use it until it is deactivated by another DCI. Type 2 CG-PUSCH provides better control for the gNB scheduler and therefore more efficiently utilises resources.

### CP-OFDM and DFT-S-OFDM

The coupling loss (CL) between the UE and the gNB depends largely on the distance between the UE and gNB, but also on any obstacles such as buildings, traffic, foliage etc that happen to be located in the line of sight between the UE and gNB. To a lesser extent, the CL is also influenced by propagation conditions such as fading due to precipitation and Doppler spread due to UE mobility. On the DL, coverage can be improved by transmitting more power from the gNB. In the UL, the situation can be more dire considering that the power a UE of a given class can transmit is limited by regulation, even if the UE batteries can sustain a higher power. There is therefore a limit to boosting UL coverage by increasing the transmit power.

Given the CL, it is thus desirable to be able to improve cell coverage, especially for UEs located at the edge of a cell. 3GPP has already completed a base version of 5G in 3GPP Release 15 known as New Radio (NR) and further enhancements have been added in 3GPP Releases 16 and 17. In these releases, the transmission in the downlink is based on a Cyclic Prefix—Orthogonal Frequency Division Multiplexing (CP-OFDM) waveform while the uplink can use either CP-OFDM or Discrete Fourier Transform spread Orthogonal Frequency Division Multiplexing (DFT-S-OFDM) waveforms.

A benefit of supporting DFT-S-OFDM in the uplink is to increase the coverage due to its lower peak-to-average power ratio (PAPR) than CP-OFDM, particularly when a UE is at the cell edge. The lower PAPR allows the UE to transmit with a higher average power which improves the UL coverage. DFT-S-OFDM is a form of transform precoding. The DFT-S-OFDM waveform can be used in a Single Carrier Frequency Division Multiple Access (SC-FDMA) multiple access scheme. Alternatively, the UE can transmit at the same radiated power level in a more efficient manner since the power amplifier in the UE can be operated with less backoff. However, DFT-S-OFDM as implemented in 3GPP Release 15 to Release 17 supports only single stream/layer transmission in order to reduce implementation complexity.

It is mandatory for all Release 17 NR-capable UEs to support both CP-OFDM and DFT-S-OFDM as UL transmission waveforms. In normal use, in terms of informing a UE of which waveform to use in the uplink, a UE receives higher layer “broadcast” signalling (in e.g. System Information Block 1, SIB1) to enable or disable the usage of DFT-S-OFDM for Msg3 transmission during the random access procedure. Alternatively, a UE may receive dedicated semi-static (e.g., Radio Resource Control, RRC) signalling as a part of PUSCH (Physical Uplink Shared Channel) configuration for UL transmissions. The configuration details to support both CP-OFDM and DFT-S-OFDM in the uplink are captured in [3], section 6.1.3, for example.

As described above, DFT-S-OFDM is similar to single carrier waveforms in having a lower PAPR than the multi-carrier CP-OFDM waveform. A transmitter using DFT-S-OFDM can therefore operate its output power amplifier at its non-linear characteristic region without fear of excessive waveform clipping, thereby engendering a lower Adjacent Channel Leakage Ratio (ACLR) and reduced interference at the victim receiver in an adjacent channel. Further, because of its lower ACLR (which is the ratio of the power within the assigned frequency channel to the power in the adjacent channel), the UE can operate with a lower maximum power reduction (MPR) factor than a UE transmitting using CP-OFDM. This means that a UE transmitting using DFT-S-OFDM in the UL is allowed to transmit more power (in some cases as much as 1.5 dB more power) than a UE using CP-OFDM. The use of DFT-S-OFDM therefore allows a given UE to achieve the maximum output power for its class very efficiently whilst saving battery power. Furthermore, as DFT-S-OFDM does not support multiple-input-and-multiple-output (MIMO) transmission, cross spatial interference is absent, meaning that for the same UE transmit power, DFT-S-OFDM can provide significantly more coverage than CP-OFDM. On the other hand, this lack of support for MIMO mitigates against the use of DFT-S-OFDM for reasons of inefficient use of communications resources. This means that for a typical network, the majority of the UEs would be configured to use CP-OFDM when in good coverage.

This suggests that it would be advantageous for a UE with CP-OFDM configured as its UL waveform, when needing to increase its coverage because, for example, it is about to fall out of good coverage, to be configured to switch to DFT-S-OFDM; for either all UL transmissions such as PUSCH, or only those that are out of coverage.

Configuration of the UL waveform for Msg 3 of the 4-step RACH procedure in Release 17 is done via the msg3-transformPrecoding field of the SIBI RACH-ConfigCommon information element (IE). As this is configured in the SIB, it is cell-specific and so common for all UEs whether in or out of coverage. Therefore, it is not technically viable to use such SIBs to instruct UEs in poor coverage or out of coverage UEs to switch to DFT-S-OFDM, as UEs in good coverage and which are not likely to drop out of good coverage will also receive such SIBs. Performing such signalling to instruct UEs in poor coverage or out of coverage UEs to switch from CP-OFDM to DFT-S-OFDM via SIBs then would require, for example, the specification of a new, different type of SIB which would thus have fairly significant specification impact.

Semi-static configuration of the UL waveform for dynamic grant is achieved in Release 17 via the transformPrecoding field of the RRC PUSCH-Config IE. Similarly, for configured grant, it is achieved via the transformPrecoding field of the RRC ConfiguredGrantConfig IE. Semi-static configuration via RRC means that the UE can be configured to use DFT-S-OFDM indefinitely, until changed by a new RRC configuration. The network could do this when it decides that the UE is either in a coverage limited situation or out of coverage (or about to fall out of coverage). However, as RRC configuration can be slow, the UE may have gone out of coverage without having a chance to ACK and apply the RRC command.

It is therefore necessary to find a more efficient method of instructing a UE to switch waveform to DFT-S-OFDM, particularly when that UE is in poor coverage, out of coverage, or about to go out of coverage. Embodiments of the present technique therefore seek to provide solutions to address such a problem.

### NR Waveform Switching for Coverage Extension

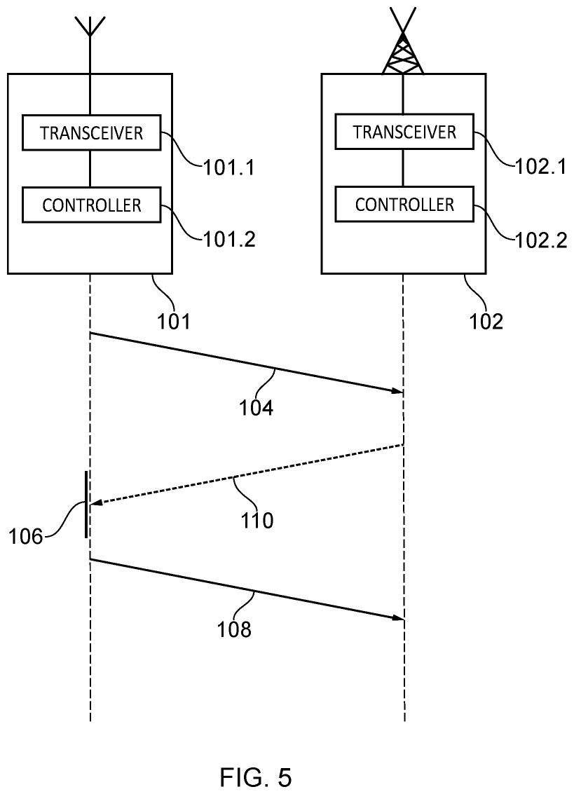

FIG. 5 shows a part schematic, part message flow diagram representation of a wireless communications system comprising a communications device (e.g. UE) 101 and an infrastructure equipment (e.g. gNB) 102 in accordance with at least some embodiments of the present technique. The communications device 101 is configured to transmit signals to and/or receive signals from the wireless communications network, for example, to and from the infrastructure equipment 102. Specifically, the communications device 101 may be configured to transmit data to and/or receive data from the wireless communications network (e.g. to/from the infrastructure equipment 102) via a wireless radio interface provided by the wireless communications network (e.g. a Uu interface between the communications device 101 and the Radio Access Network (RAN), which includes the infrastructure equipment 102). The communications device 101 and the infrastructure equipment 102 each comprise a transceiver (or transceiver circuitry) 101.1, 102.1, and a controller (or controller circuitry) 101.2, 102.2. Each of the controllers 101.2, 102.2 may be, for example, a microprocessor, a CPU, or a dedicated chipset, etc.

As shown in the example of FIG. 5, the transceiver circuitry 101.1 and the controller circuitry 101.2 of the communications device 101 are configured in combination to transmit 104, to a cell (e.g. formed by infrastructure equipment 102) of the wireless communications network, a first uplink signal based on a first waveform type (e.g. CP-OFDM), to determine 106 (for example, based on receiving 110 an indication from the cell of the wireless communications network (e.g. from the infrastructure equipment 102)), that the communications device 101 is to transmit a second uplink signal based on a second waveform type (e.g. DFT-S-OFDM) instead of the first waveform type based on a predetermined condition being met, the second waveform type being different to the first waveform type, and to transmit 108, to the cell of the wireless communications network (e.g. to the infrastructure equipment 102), the second uplink signal based on the second waveform type. Here, the predetermined condition may comprise (or may be indicative of) the communications device 101 moving outside of an uplink coverage region of the cell of the wireless communications network, or the predetermined condition may comprise the UE being handed (or about to be handed) over to a non-terrestrial network (NTN) or the like where the use of a waveform such as DFT-S-OFDM would be advantageous.

For an RRC-Idle mode UE that happens to be out of normal coverage, such a UE can likely still reach the network with RACH Msg1 (i.e. of the 4-step RACH procedure) because of the PRACH power ramping that can be engaged during the RACH process. In other words, the first uplink signal may be a first message (e.g. msg1) of a (4-step) random access, RACH, procedure initiated by the communications device with the cell of the wireless communications network. Here, the communications device may be configured to determine when it does not receive a RAR that the first uplink signal has not been successfully received by the cell of the wireless communications network, and to retransmit the first uplink signal one or more times until determining that it has been successfully received by the cell of the wireless communications network. Here, a transmission power of each retransmission of the first uplink signal is increased with respect to the previous transmission of the first uplink signal.

The gNB may be able to use various means to determine whether or not the UE is outside of normal coverage. Based on, for example, a last known location of the UE (which may be used to page the UE), or on the number of PRACH retransmissions performed by the UE, or on a particular preamble used for the successful retransmission by the UE (where such preambles may indicate or otherwise be associated with the power ramping level—eg. UE could send its final power-ramped preambles using a different sequence. The gNB would detect that the UE had used a high power ramp on the preamble based on the preamble ID), or on a subset of preambles where the gNB reserves a subset of preambles for UE in poor coverage or out of coverage and another subset for UEs in normal coverage (i.e. preamble partitioning), the gNB may be able to detect whether or not the UE is outside of normal coverage. Another way the gNB may be able to determine whether the UE is outside of normal coverage may be made on a RACH occasion used by the UE to transmit the first signal (i.e. RACH preamble)—e.g. some RACH occasions may be used for UEs in normal coverage and other ROs may be used for UEs requiring coverage extension. In coverage extension, the UE would repeat preambles. If there are known starting points (ROs) for these repeats and the gNB only detects the preamble in a late RO, the gNB may know that the UE was in poor coverage.

If the UE has to power ramp PRACH above a certain level, it should determine in accordance with some embodiments of the present technique that it should use DFT-S-OFDM for Msg3 or msgA PUSCH. In other words, the communications device may be configured to determine that the first uplink signal has not been successfully received by the cell of the wireless communications network, to retransmit the first uplink signal one or more times, wherein a transmission power of each retransmission of the first uplink signal is increased with respect to the previous transmission of the first uplink signal, and to determine, based on the transmission power of one of the retransmissions of the first uplink signal being above a specified threshold power, that the communications device is to transmit the second uplink signal based on the second waveform type instead of the first waveform type based on the predetermined condition being met.

The UE can also decide whether to use DFT-S-OFDM or CP-OFDM for Msg 3 or msgA based on whether the transmission power for the PRACH is above a threshold. That is the UE can decide on this regardless of whether it needs to perform power ramping or not. The said power threshold can be RRC configured (e.g. in the SIBs or UE dedicated signalling) or predefined in the specifications.

In the above two described arrangements of embodiments of the present technique, the UE may autonomously decide which waveform to use based on either the amount of power ramping and/or whether the preamble transmit power is above the threshold. The gNB may have to blind decode Msg 3 or msgA PUSCH since it is unaware which waveform the UE has selected, by attempting to decode it assuming UE has transmitted both DFT-S-OFDM and CP-OFDM. The gNB can estimate whether the UE is at the cell edge or out of coverage, and if so, it can attempt to decode it using DFT-S-OFDM first; and if that fails it uses CP-OFDM, and vice-versa for the case that the gNB is aware the UE is in coverage. In other words, the infrastructure equipment may be configured to determine that the first uplink signal is a first message of a random access, RACH, procedure (e.g. msgA PRACH of a 2-step RACH procedure or Msg1 of a 4-step RACH procedure) initiated by the communications device with the cell of the wireless communications network, and to receive the second signal by blindly decoding the second signal in accordance with each of the first waveform type and the second waveform type.

As those skilled in the art would appreciate, multi PRACH transmission is a method for a UE in cell edge or out of coverage to reach the gNB by transmitting multiple PRACH, using the same preamble, to the gNB. The gNB would combine these multiple PRACH transmissions to improve its SNR. Hence, in another implementation of embodiments of the present disclosure, the gNB can determine that the UE is out of coverage by determining the number of multiple PRACH transmissions the UE made for Msg 1, for example, if the number of PRACH transmissions for a Msg 1 is higher than a threshold, the UE will use DFT-S-OFDM waveform, otherwise it uses CP-OFDM. This said threshold can be configured in the SIB or defined in the specifications.

There are implementation specific methods that the network vendor can use to determine whether the UE is out of coverage. For example, in the prior art in eMTC, the eNB can estimate the UE's location based on the last known location whilst the UE was connected and if the UE was cell edge, the eNB can adjust its repetitions for its paging message assuming it is at the cell edge. Similar and other mechanisms can of course be used to determine an Idle Mode UE's location as those skilled in the art would be aware.

Alternatively or additionally, if the gNB can determine whether the UE is in coverage, at cell edge or out of coverage, e.g. using a vendor specific implementation or a standardised method such as preamble/RACH Occasions partitioning or based on the number of multi PRACH transmissions, the gNB can include in the random access response (RAR) a new bit (e.g. a reserved—i.e. “R” bit of the RAR as would be known to those skilled in the art) used for informing the out of coverage UE that it should use DFT-S-OFDM for Msg3 (4-step RACH)—where this Msg3 might be the second uplink signal transmitted by the UE. In other words, in accordance with such arrangements of embodiments of the present technique, the indication may be received by the communications device from the cell of the wireless communications network within a random access response, RAR, message in response to the first message of the RACH procedure, wherein the indication may be carried by a reserved bit of the RAR message. The infrastructure equipment may be configured to transmit the indication to the communications device based on determining that the UE is at the cell edge or out of coverage.

In at least some such arrangements of embodiments of the present technique, for 2-step RACH, the gNB, having determined the UE is at the cell edge or out of coverage, engages a DFT-S-OFDM receiver for the msgA PUSCH.

As well as the UE determining that is to transmit the second uplink signal based on the second waveform type (e.g. DFT-S-OFDM) instead of the first waveform type based on the predetermined condition (e.g. the UE going out of coverage or out of good coverage) being met based on the indication in the RAR or its PRACH ramping power going above a threshold power, the UE in accordance with some arrangements of embodiments of the present technique may determine it should switch waveform based on other received indications from the network. In other words, the communications device may be configured to receive, from the cell of the wireless communications network, an indication that the communications device is to transmit the second uplink signal based on the second waveform type, and to determine, based on the received indication, that the communications device is to transmit the second uplink signal based on the second waveform type instead of the first waveform type based on the predetermined condition being met.

For example, for an RRC-Connected or RRC-Inactive mode UE that happens to be out of (good) UL coverage, the SIBI transformPrecoding field can be over-ridden in some arrangements via new RRC or MAC CE signalling. In other words, the indication may be received by the communications device from the cell of the wireless communications network in semi-static signalling, where here the semi-static signalling may radio resource control, RRC, signalling or the indication may be carried by a medium access control, MAC, control element.

In some such arrangements of embodiments of the present technique, this overwriting RRC or MAC CE signalling may be telling the UE to use DFT-S-OFDM for Msg3 (4-step RACH) or msgA PUSCH (2-step RACH) transmissions. In other words, the semi-static signalling may comprise an instruction for the communications device to initiate a (4-step or 2-step) random access, RACH, procedure with the cell of the wireless communications network, and wherein the second uplink signal is a message (e.g. msg3 or msgA) of the RACH procedure

Other arrangements of embodiments of the present disclosure exist for RACH processes while the UE is in RRC-Connected mode. For example, the gNB can also include indicate waveform in the PDCCH order for the UE to RACH. In other words, the indication may be received by the communications device from the cell of the wireless communications network in a control signal instructing the communications device to initiate a random access, RACH, procedure with the cell of the wireless communications network, and wherein the second uplink signal is a message of the RACH procedure.

In other arrangements of embodiments of the present technique, the indication may be received by the communications device from the infrastructure equipment in DCI. For example, for PUSCH, there are dynamically granted and configured grant PUSCHs that are configured for UL data transmission. As RRC signaling can be rather slow, in terms of dynamic configuration, the command to switch to/from DFT-S-OFDM can be sent in the DCI that schedules the PUSCH or sets up or activates the CG. In other words, the DCI may indicate uplink resources to be used by the communications device to transmit the second uplink signal, or the DCI may be an activation DCI indicating that grant-free resources in which the communications device is able to transmit signals to the cell of the wireless communications network are activated or deactivated. For this, an additional bit may need to be added to the scheduling/activation DCI. It should be noted by those skilled in the art that this option may engender a significant specification impact.

It should be noted by those skilled in the art that, in arrangements of embodiments of the present technique where the UE may determine it should switch waveform based on received indications from the network, such indications may be received based on the UE being out of good coverage (i.e. it is in DL coverage but not good UL coverage, for example because it is based at the cell edge), or based on the UE being totally out of UL coverage. In other words, the indication may be received by the communications device from the cell of the wireless communications network in response to the communications device moving outside an area of good coverage of the cell of the wireless communications network or in response to the communications device moving fully outside an area of coverage of the cell of the wireless communications network. In some other arrangements of embodiments of the present technique, the indication may be received in advance of the UE going out of coverage, such that the UE knows that, when it detects it has gone out of coverage at a later time, it should switch to the second waveform (e.g. DFT-S-OFDM) without having to wait for further instruction from the network. In other words, the indication may be received by the communications device from the cell of the wireless communications network in advance of the communications device moving out of the uplink coverage region of the cell of the wireless communications network.

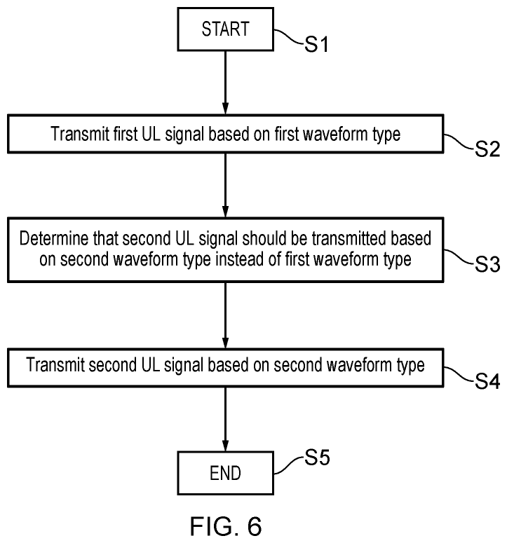

FIG. 6 shows a flow diagram illustrating an example process of communications in a communications system in accordance with embodiments of the present technique. The process shown by FIG. 6 is a method of operating a communications device.

The method begins in step S1. The method comprises, in step S2, transmitting, to a cell of a wireless communications network, a first uplink signal based on a first waveform type. In step S3, the method comprises determining that the communications device is to transmit a second uplink signal based on a second waveform type instead of the first waveform type based on a predetermined condition being met, the second waveform type being different to the first waveform type. Then, in step S4, the process comprises transmitting, to the cell of the wireless communications network, the second uplink signal based on the second waveform type. Here, the predetermined condition may comprise (or be indicative of) the communications device moving outside of an uplink coverage region of the cell of the wireless communications network. The process ends in step S5.

Those skilled in the art would appreciate that the method shown by FIG. 6 may be adapted in accordance with embodiments of the present technique. For example, other intermediate steps may be included in this method, or the steps may be performed in any logical order. Though embodiments of the present technique have been described largely by way of the example communications system shown in FIG. 5, it would be clear to those skilled in the art that they could be equally applied to other systems to those described herein.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:
Paragraph 1. A method of operating a communications device, the method comprising
transmitting, to a cell of a wireless communications network, a first uplink signal based on a first waveform type,
determining that the communications device is to transmit a second uplink signal based on a second waveform type instead of the first waveform type based on a predetermined condition being met, the second waveform type being different to the first waveform type, and
transmitting, to the cell of the wireless communications network, the second uplink signal based on the second waveform type.
Paragraph 2. A method according to Paragraph 1, wherein the predetermined condition comprises the communications device moving outside of an uplink coverage region of the cell of the wireless communications network.
Paragraph 3. A method according to Paragraph 1 or Paragraph 2, comprising
determining autonomously that the communications device is to transmit the second uplink signal based on the second waveform type instead of the first waveform type based on the predetermined condition being met.
Paragraph 4. A method according to any of Paragraphs 1 to 3, comprising
receiving, from the cell of the wireless communications network, an indication that the communications device is to transmit the second uplink signal based on the second waveform type, and
determining, based on the received indication, that the communications device is to transmit the second uplink signal based on the second waveform type instead of the first waveform type based on the predetermined condition being met.
Paragraph 5. A method according to Paragraph 4, wherein the indication is received by the communications device from the cell of the wireless communications network in downlink control information, DCI.
Paragraph 6. A method according to Paragraph 5, wherein the DCI indicates uplink resources to be used by the communications device to transmit the second uplink signal.
Paragraph 7. A method according to Paragraph 5 or Paragraph 6, wherein the DCI is an activation DCI indicating that grant-free resources in which the communications device is able to transmit signals to the cell of the wireless communications network are activated or deactivated.
Paragraph 8. A method according to any of Paragraphs 4 to 7, wherein the indication is received by the communications device from the cell of the wireless communications network in a control signal instructing the communications device to initiate a random access, RACH, procedure with the cell of the wireless communications network, and wherein the second uplink signal is a message of the RACH procedure.
Paragraph 9. A method according to any of Paragraphs 4 to 8, wherein the indication is received by the communications device from the cell of the wireless communications network in semi-static signalling.
Paragraph 10. A method according to Paragraph 9, wherein the semi-static signalling is radio resource control, RRC, signalling.
Paragraph 11. A method according to any of Paragraphs 4 to 10, wherein the indication comprises an instruction for the communications device to initiate a random access, RACH, procedure with the cell of the wireless communications network, and wherein the second uplink signal is a message of the RACH procedure.
Paragraph 12. A method according to any of Paragraphs 4 to 11, wherein the indication is carried by a medium access control, MAC, control element.
Paragraph 13. A method according to any of Paragraphs 4 to 12, wherein the indication is received by the communications device from the cell of the wireless communications network in response to the communications device moving outside an area of good coverage of the cell of the wireless communications network.
Paragraph 14. A method according to any of Paragraphs 4 to 13, wherein the indication is received by the communications device from the cell of the wireless communications network in response to the communications device moving fully outside an area of coverage of the cell of the wireless communications network.
Paragraph 15. A method according to any of Paragraphs 4 to 14, wherein the indication is received by the communications device from the cell of the wireless communications network in advance of the communications device moving out of the uplink coverage region of the cell of the wireless communications network.
Paragraph 16. A method according to any of Paragraphs 4 to 15, wherein the first uplink signal is a first message of a random access, RACH, procedure initiated by the communications device with the cell of the wireless communications network.
Paragraph 17. A method according to Paragraph 16, comprising
determining that the first uplink signal has not been successfully received by the cell of the wireless communications network, and
retransmitting the first uplink signal one or more times until determining that it has been successfully received by the cell of the wireless communications network, wherein a transmission power of each retransmission of the first uplink signal is increased with respect to the previous transmission of the first uplink signal.
Paragraph 18. A method according to Paragraph 17, wherein the indication is received by the communications device from the cell of the wireless communications network based on a preamble used by the communications device for the retransmission of the first uplink signal that was successfully received by the cell of the wireless communications network being from a set of one or more preambles associated with transmission powers above a specified threshold power.
Paragraph 19. A method according to any of Paragraphs 16 to 18, comprising
determining that the first uplink signal has not been successfully received by the cell of the wireless communications network, and
retransmitting the first uplink signal one or more times until determining that it has been successfully received by the cell of the wireless communications network, wherein a RACH occasion used for each retransmission of the first uplink signal is changed with respect to the previous transmission of the first uplink signal,
wherein the indication is received by the communications device from the cell of the wireless communications network based on the RACH occasion used by the communications device for the retransmission of the first uplink signal that was successfully received by the cell of the wireless communications network.
Paragraph 20. A method according to any of Paragraphs 16 to 19, comprising
determining that the first uplink signal has not been successfully received by the cell of the wireless communications network, and
retransmitting the first uplink signal one or more times until determining that it has been successfully received by the cell of the wireless communications network,
wherein the indication is received by the communications device from the cell of the wireless communications network based on the number of retransmissions performed by the communications device before determining that the first uplink signal has been successfully received by the cell of the wireless communications network being above a specified threshold
Paragraph 21. A method according to any of Paragraphs 16 to 20, wherein the indication is received by the communications device from the cell of the wireless communications network within a random access response, RAR, message in response to the first message of the RACH procedure, wherein the indication is carried by a reserved bit of the RAR message.
Paragraph 22. A method according to any of Paragraphs 16 to 21, comprising
retransmitting the first uplink signal one or more times in accordance with a multi-PRACH transmission mode,
wherein the indication is received by the communications device from the cell of the wireless communications network based on the number of retransmissions used in the multi-PRACH transmission for the first message of the RACH procedure being above a specified threshold.
Paragraph 23. A method according to any of Paragraphs 4 to 22, wherein the indication is received by the communications device from the cell of the wireless communications network based on the communication device transmitting the first uplink signal with a preamble selected from a predetermined set of preambles.
Paragraph 24. A method according to any of Paragraphs 4 to 23, wherein the indication is received by the communications device from the cell of the wireless communications network based on the communication device transmitting the first uplink signal in a RACH Occasion from a predetermined set of RACH Occasions.
Paragraph 25. A method according to any of Paragraphs 1 to 24, wherein the first uplink signal is a first message of a random access, RACH, procedure initiated by the communications device with the cell of the wireless communications network, and wherein the method comprises
determining that the first uplink signal has not been successfully received by the cell of the wireless communications network,
retransmitting the first uplink signal one or more times, wherein a transmission power of each retransmission of the first uplink signal is increased with respect to the previous transmission of the first uplink signal, and
determining, based on the transmission power of one of the retransmissions of the first uplink signal being above a specified threshold power, that the communications device is to transmit the second uplink signal based on the second waveform type instead of the first waveform type.
Paragraph 26. A method according to any of Paragraphs 1 to 25, wherein the first uplink signal is a first message of a random access, RACH, procedure initiated by the communications device with the cell of the wireless communications network, and wherein the method comprises
determining, based on the transmission power of one of transmissions of the first uplink signal being above a specified threshold power, that the communications device is to transmit the second uplink signal based on the second waveform type instead of the first waveform type.
Paragraph 27. A method according to any of Paragraphs 1 to 26, wherein the second waveform type is Discrete Fourier Transform spread Orthogonal Frequency Division Multiplexing, DFT-S-OFDM.
Paragraph 28. A communications device comprising
transceiver circuitry, and
controller circuitry configured in combination with the transceiver circuitry
to transmit, to a cell of a wireless communications network, a first uplink signal based on a first waveform type,
to determine that the communications device is to transmit a second uplink signal based on a second waveform type instead of the first waveform type based on a predetermined condition being met, the second waveform type being different to the first waveform type, and
to transmit, to the cell of the wireless communications network, the second uplink signal based on the second waveform type.
Paragraph 29. Circuitry for a communications device comprising
transceiver circuitry, and
controller circuitry configured in combination with the transceiver circuitry
to transmit, to a cell of a wireless communications network, a first uplink signal based on a first waveform type,
to determine that the communications device is to transmit a second uplink signal based on a second waveform type instead of the first waveform type based on a predetermined condition being met, the second waveform type being different to the first waveform type, and
to transmit, to the cell of the wireless communications network, the second uplink signal based on the second waveform type.
Paragraph 30. A method of operating an infrastructure equipment forming part of a first wireless communications network, the method comprising
receiving, from a communications device, a first uplink signal based on a first waveform type,
determining that the communications device is to transmit a second uplink signal based on a second waveform type instead of the first waveform type based on a predetermined condition being met, the second waveform type being different to the first waveform type, and
receiving, from the communications device, the second uplink signal based on the second waveform type.
Paragraph 31. A method according to Paragraph 30, wherein the predetermined condition comprises the communications device moving outside of an uplink coverage region of the cell of the wireless communications network formed by the infrastructure equipment.
Paragraph 32. A method according to Paragraph 30 or Paragraph 31, comprising
transmitting, to the communications device, an indication that the communications device is to transmit the second uplink signal based on the second waveform type.
Paragraph 33. A method according to Paragraph 32, wherein the indication is transmitted to the communications device by the infrastructure equipment in downlink control information, DCI.
Paragraph 34. A method according to Paragraph 33, wherein the DCI indicates uplink resources to be used by the communications device to transmit the second uplink signal.
Paragraph 35. A method according to Paragraph 33 or Paragraph 34, wherein the DCI is an activation DCI indicating that grant-free resources in which the communications device is able to transmit signals to the infrastructure equipment are activated or deactivated.
Paragraph 36. A method according to any of Paragraphs 32 to 35, wherein the indication is transmitted to the communications device by the infrastructure equipment in a control signal instructing the communications device to initiate a random access, RACH, procedure with the infrastructure equipment, and wherein the second uplink signal is a message of the RACH procedure.
Paragraph 37. A method according to any of Paragraphs 32 to 36, wherein the indication is transmitted to the communications device by the infrastructure equipment in semi-static signalling.
Paragraph 38. A method according to Paragraph 37, wherein the semi-static signalling is radio resource control, RRC, signalling.
Paragraph 39. A method according to any of Paragraphs 32 to 38 wherein the indication comprises an instruction for the communications device to initiate a random access, RACH, procedure with the infrastructure equipment, and wherein the second uplink signal is a message of the RACH procedure.
Paragraph 40. A method according to any of Paragraphs 32 to 39, wherein the indication is carried by a medium access control, MAC, control element.
Paragraph 41. A method according to any of Paragraphs 32 to 40, wherein the indication is transmitted to the communications device by the infrastructure equipment in response to the communications device moving fully outside an area of coverage of the infrastructure equipment.
Paragraph 42. A method according to any of Paragraphs 32 to 41, wherein the indication is transmitted to the communications device by the infrastructure equipment in response to the communications device moving outside an area of good coverage of the infrastructure equipment.
Paragraph 43. A method according to any of Paragraphs 32 to 42, wherein the indication is transmitted to the communications device by the infrastructure equipment in advance of the communications device moving out of the uplink coverage region of the infrastructure equipment.
Paragraph 44. A method according to any of Paragraphs 32 to 43, wherein the first uplink signal is a first message of a random access, RACH, procedure initiated by the communications device with the infrastructure equipment.
Paragraph 45. A method according to Paragraph 44, comprising
receiving the first uplink signal from the communications device as a successfully received retransmission from among one or more retransmissions of the first uplink signal, wherein a transmission power of each retransmission of the first uplink signal is increased at the communications device with respect to the previous transmission of the first uplink signal.
Paragraph 46. A method according to Paragraph 45, wherein the indication is transmitted to the communications device by the infrastructure equipment based on a preamble used by the communications device for the successfully received retransmission being from a set of one or more preambles associated with transmission powers above a specified threshold power.
Paragraph 47. A method according to any of Paragraphs 44 to 46, comprising
receiving the first uplink signal from the communications device as a successfully received retransmission from among one or more retransmissions of the first uplink signal, wherein a RACH occasion used for each retransmission of the first uplink signal is changed with respect to the previous transmission of the first uplink signal,
wherein the indication is transmitted to the communications device by the infrastructure equipment based on the RACH occasion used by the communications device for the successfully received retransmission.
Paragraph 48. A method according to any of Paragraphs 44 to 47, comprising
receiving the first uplink signal from the communications device as a successfully received retransmission from among one or more retransmissions of the first uplink signal,
wherein the indication is transmitted to the communications device by the infrastructure equipment based on the number of retransmissions determined by the infrastructure equipment to have been performed by the communications device before the successfully received retransmission being above a specified threshold
Paragraph 49. A method according to any of Paragraphs 32 to 48, wherein the indication is transmitted to the communications device by the infrastructure equipment based on the communication device transmitting the first uplink signal with a preamble selected from a predetermined set of preambles.
Paragraph 50. A method according to any of Paragraphs 32 to 49, wherein the indication is transmitted to the communications device by the infrastructure equipment based on the communication device transmitting the first uplink signal in a RACH Occasion from a predetermined set of RACH Occasions.
Paragraph 51. A method according to any of Paragraphs 32 to 50, comprising
determining the number of retransmissions of the first uplink signal performed by the communications device in accordance with a multi-PRACH transmission mode is above a specified threshold,
wherein the indication is transmitted to the communications device by the infrastructure equipment based on the number of retransmissions used in the multi-PRACH transmission for the first message of the RACH procedure being above the specified threshold.
Paragraph 52. A method according to any of Paragraphs 32 to 51, wherein the indication is transmitted to the communications device by the infrastructure equipment within a random access response, RAR, message in response to the first message of the RACH procedure, wherein the indication is carried by a reserved bit of the RAR message.
Paragraph 53. A method according to any of Paragraphs 30 to 52, comprising
determining that the first uplink signal is a first message of a random access, RACH, procedure initiated by the communications device with the cell of the wireless communications network, and
receiving the second signal by blindly decoding the second signal in accordance with each of the first waveform type and the second waveform type.
Paragraph 54. A method according to any of Paragraphs 30 to 53, wherein the second waveform type is Discrete Fourier Transform spread Orthogonal Frequency Division Multiplexing, DFT-S-OFDM.
Paragraph 55. An infrastructure equipment forming part of a first wireless communications network, the infrastructure equipment comprising
transceiver circuitry, and
controller circuitry configured in combination with the transceiver circuitry
to receive, from a communications device, a first uplink signal based on a first waveform type,
to determine that the communications device is to transmit a second uplink signal based on a second waveform type instead of the first waveform type based on a predetermined condition being met, the second waveform type being different to the first waveform type, and
to receive, from the communications device, the second uplink signal based on the second waveform type.
Paragraph 56. Circuitry for an infrastructure equipment forming part of a first wireless communications network, the infrastructure equipment comprising
transceiver circuitry, and
controller circuitry configured in combination with the transceiver circuitry
to receive, from a communications device, a first uplink signal based on a first waveform type,
to determine that the communications device is to transmit a second uplink signal based on a second waveform type instead of the first waveform type based on a predetermined condition being met, the second waveform type being different to the first waveform type, and
to receive, from the communications device, the second uplink signal based on the second waveform type.
Paragraph 57. A wireless communications system comprising a communications device according to Paragraph 28 and an infrastructure equipment according to Paragraph 55.
Paragraph 58. A computer program comprising instructions which, when loaded onto a computer, cause the computer to perform a method according to any of Paragraphs 1 to 27 or Paragraphs 30 to 54.
Paragraph 59. A non-transitory computer-readable storage medium storing a computer program according to Paragraph 58.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### References

[1] Holma H. and Toskala A, “LTE for UMTS OFDMA and SC-FDMA based radio access”, John Wiley and Sons, 2009.
[2] TR 38.913, “3rd Generation Partnership Project; Technical Specification Group Radio Access Network; Study on Scenarios and Requirements for Next Generation Access Technologies (Release 14)”, 3GPP, v14.3.0, August 2017.
[3] TS 38.214, “3rd Generation Partnership Project; Technical Specification Group Radio Access Network; NR; Physical layer procedures for data (Release 15)”, 3GPP, v15.16.0, March 2022.

1. A method of operating a communications device, the method comprising
transmitting, to a cell of a wireless communications network, a first uplink signal based on a first waveform type,
determining that the communications device is to transmit a second uplink signal based on a second waveform type instead of the first waveform type based on a predetermined condition being met, the second waveform type being different to the first waveform type, and
transmitting, to the cell of the wireless communications network, the second uplink signal based on the second waveform type.

2. A method according to claim 1, wherein the predetermined condition comprises the communications device moving outside of an uplink coverage region of the cell of the wireless communications network.

3. A method according to claim 1, comprising
determining autonomously that the communications device is to transmit the second uplink signal based on the second waveform type instead of the first waveform type based on the predetermined condition being met.

4. A method according to claim 1, comprising
receiving, from the cell of the wireless communications network, an indication that the communications device is to transmit the second uplink signal based on the second waveform type, and
determining, based on the received indication, that the communications device is to transmit the second uplink signal based on the second waveform type instead of the first waveform type based on the predetermined condition being met.

5. A method according to claim 4, wherein the indication is received by the communications device from the cell of the wireless communications network in downlink control information, DCI.

6. A method according to claim 5, wherein the DCI indicates uplink resources to be used by the communications device to transmit the second uplink signal.

7. A method according to claim 5, wherein the DCI is an activation DCI indicating that grant-free resources in which the communications device is able to transmit signals to the cell of the wireless communications network are activated or deactivated.

8. A method according to claim 4, wherein the indication is received by the communications device from the cell of the wireless communications network in a control signal instructing the communications device to initiate a random access, RACH, procedure with the cell of the wireless communications network, and wherein the second uplink signal is a message of the RACH procedure.

9. A method according to claim 4, wherein the indication is received by the communications device from the cell of the wireless communications network in semi-static signalling.

10. A method according to claim 9, wherein the semi-static signalling is radio resource control, RRC, signalling.

11. A method according to claim 4, wherein the indication comprises an instruction for the communications device to initiate a random access, RACH, procedure with the cell of the wireless communications network, and wherein the second uplink signal is a message of the RACH procedure.

12. A method according to claim 4, wherein the indication is carried by a medium access control, MAC, control element.

13. A method according to claim 4, wherein the indication is received by the communications device from the cell of the wireless communications network in response to the communications device moving outside an area of good coverage of the cell of the wireless communications network.

14. A method according to claim 4, wherein the indication is received by the communications device from the cell of the wireless communications network in response to the communications device moving fully outside an area of coverage of the cell of the wireless communications network.

15. A method according to claim 4, wherein the indication is received by the communications device from the cell of the wireless communications network in advance of the communications device moving out of the uplink coverage region of the cell of the wireless communications network.

16. A method according to claim 4, wherein the first uplink signal is a first message of a random access, RACH, procedure initiated by the communications device with the cell of the wireless communications network.

17. A method according to claim 16, comprising
determining that the first uplink signal has not been successfully received by the cell of the wireless communications network, and
retransmitting the first uplink signal one or more times until determining that it has been successfully received by the cell of the wireless communications network, wherein a transmission power of each retransmission of the first uplink signal is increased with respect to the previous transmission of the first uplink signal.

18. (canceled)

19. A method according to claim 16, comprising
determining that the first uplink signal has not been successfully received by the cell of the wireless communications network, and
retransmitting the first uplink signal one or more times until determining that it has been successfully received by the cell of the wireless communications network, wherein a RACH occasion used for each retransmission of the first uplink signal is changed with respect to the previous transmission of the first uplink signal,
wherein the indication is received by the communications device from the cell of the wireless communications network based on the RACH occasion used by the communications device for the retransmission of the first uplink signal that was successfully received by the cell of the wireless communications network.

20.-27. (canceled)

28. A communications device comprising
transceiver circuitry, and
controller circuitry configured in combination with the transceiver circuitry
to transmit, to a cell of a wireless communications network, a first uplink signal based on a first waveform type,
to determine that the communications device is to transmit a second uplink signal based on a second waveform type instead of the first waveform type based on a predetermined condition being met, the second waveform type being different to the first waveform type, and
to transmit, to the cell of the wireless communications network, the second uplink signal based on the second waveform type.

29.-54. (canceled)

55. An infrastructure equipment forming part of a first wireless communications network, the infrastructure equipment comprising
transceiver circuitry, and
controller circuitry configured in combination with the transceiver circuitry
to receive, from a communications device, a first uplink signal based on a first waveform type,
to determine that the communications device is to transmit a second uplink signal based on a second waveform type instead of the first waveform type based on a predetermined condition being met, the second waveform type being different to the first waveform type, and
to receive, from the communications device, the second uplink signal based on the second waveform type.

56.-59. (canceled)
